(19) United States
(12) Patent Application Publication
(10) Pub. No.: US 2015/0351875 A1
(43) Pub. Date: Dec. 10, 2015

(54) ANCHORING ELEMENT AND METHOD FOR PRODUCING SAME

(71) Applicant: BREDENT GMBH & CO. KG, Senden (DE)

(72) Inventor: Peter MIELECKE, Ulm (DE)

(73) Assignee: Bredent GmbH & Co. KG, Senden (DE)

(21) Appl. No.: 14/761,691

(22) PCT Filed: Jan. 15, 2014
(86) PCT No.: PCT/EP2014/050681

§ 371 Date: Jul. 17, 2015

(30) Foreign Application Priority Data
Jan. 18, 2013 (DE) 10 2013 100 529.2

(51) Int. Cl. A61C 8/00; B29C 70/72; B29C 70/68

(52) U.S. Cl. CPC A61C 8/0025; A61C 8/005; B29C 70/682; B29C 70/72; B29K 2071/00

(57) ABSTRACT

The invention relates to an anchoring element for a dental prosthetic arrangement, which anchoring element can be anchored in a jaw bone or implant in a first subregion (TB1) and is suitable for receiving or forming a dental prosthetic element (ZK) in a second subregion (TB2), wherein the anchoring element has, between the first subregion (TB1) and the second subregion (TB2), a radially projecting collar (KR) which at least partially encloses the circumference of the anchoring element, such that the region above the collar (KR) of the anchoring element is at least in part fully covered with a thermoplastic material. The invention further relates to a method for producing an abutment or implant, and to a method for producing a dental prosthetic arrangement using the abutment.

The invention relates to an anchoring element, a method for producing an anchoring element, and a method for producing a dental prosthetic arrangement using an abutment or implant.

Abutments are known from the general prior art are are used in many different ways in dental prosthetics. An abutment is a support element that serves to secure crowns or bridges in dentistry. Abutments are likewise used as a means of primary or secondary retention of bar-like or telescopic dental prosthetic arrangements.

An abutment usually has a metal pin which, for example in combination with an implant, is provided as an anchoring point in a jaw bone. A crown, for example, is secured on the side opposite the anchoring point.

Known abutments are usually produced from titanium. An impression is made of the dental prosthesis that is to be produced, after which a crown is prepared which is then adhesively bonded or screwed onto the abutment.

Implants are likewise known from the general prior art. They have a screw connection on a side facing the jaw bone, such that the implant can be anchored in the jaw. A crown or the like, for example, is mounted on the opposite side.

When using dental prosthetic arrangements, it is known that considerable forces often arise in the anchoring elements and can lead to mechanical stresses, such that the adhesive connections possibly come undone or mechanical damage may occur.

There is therefore a technical need to overcome the aforementioned disadvantages and to further improve known anchoring elements in the form of abutments or implants.

The object of the invention is therefore to create an anchoring element and to specify a method for producing an abutment or implant in order to achieve a further improvement upon loading.

This object is achieved by the features of claims 1 and 11. Further advantageous embodiments of the invention form the subject matter of the dependent claims. These can be combined with one another in technically feasible ways. The description, particularly with reference to the drawing, additionally characterizes and specifies the invention.

According to the first aspect of the invention, an anchoring element for a dental prosthetic arrangement is created, which anchoring element can be anchored in a jaw bone or implant in a first subregion and is suitable for receiving or forming a dental prosthetic element in a second subregion, wherein the anchoring element has, between the first subregion and the second subregion, a radially projecting collar which at least partially encloses the circumference of the anchoring element, wherein the region above the collar of the anchoring element is at least in part fully covered with a thermoplastic material.

Accordingly, in an abutment, a holding element is mounted on a retaining pin or on an implant, for example by means of hot pressing, which holding element is used as a connection between the retaining pin and a dental prosthetic element, e.g. a crown, or can form this directly by suitable shaping. The dental prosthetic element can be adhesively bonded onto the holding element or can be connected to the abutment or implant by screws. By virtue of the seamless connection between the holding element and the retaining pin, the abutment or the implant is able to take up considerable forces without coming loose or splintering. As a result, high masticatory forces can be taken up. The part of the retaining pin arranged above the collar acts as an additional reinforcement.

The anchoring element can comprise a retaining pin, which can be inserted into an implant and preferably has a non-rotationally symmetrical cross section, or an implant, which can be anchored in a jaw bone.

The anchoring element can have a roughened surface in the second subregion.

Tests have shown that a roughened surface can promote the connection of the holding element to the retaining pin or to the implant by means of hot pressing. The roughened surface can have a grain size in the range of several 100 μm, the precise configuration being dependent on the materials used for the abutment.

According to one embodiment of the invention, the holding element is produced from a thermoplastic polymer, preferably from PEEK.

PEEK (abbreviation for polyether ether ketone) is a biocompatible material used in medicine and is largely physiologically inert and therefore does not irritate patients. PEEK, like other high-performance polymers, also has a high load-bearing capacity in respect of masticatory forces, such that breaking strengths of up to 1000 MPa can be achieved. This material, compared to a lithium disilicate ceramic, therefore affords much greater safety reserves, which is important especially in use in the molars.

According to a further embodiment of the invention, the retaining pin or the implant is produced from a base metal, preferably titanium, from a ceramic, in particular aluminum oxide, or from zirconium dioxide.

Titanium is highly suitable for use in dental prosthetics in the human body. Particularly in combination with PEEK, it permits stress-free abutments, wherein the holding element made of the thermoplastic polymer and the retaining pin made of titanium are joined seamlessly to each other. However, the underlying physical or chemical effect is not fully known. It is surprisingly found that the hot-pressed polymer forms a particularly stable connection with the base metal, which connection in addition is free of cracks and gaps. It is suspected that the metal oxide forming on the surface of the base metal forms a union with the polymer chains of the holding element and that this makes the abutment particularly efficient. Ceramic materials such as aluminum oxide, or also zirconium oxide, can likewise be used.

According to a further embodiment of the invention, the retaining pin or the implant has a profiled surface on its outside in the region of the holding element.

A profiled surface forms retentive areas such that, after hot pressing, the plastic material of the thermoplastic polymer can retreat into these areas during cooling. This promotes the complete, i.e. seamless, coverage of the retaining pin with the thermoplastic.

The profiled surface can comprise several ribs arranged in parallel in the axial direction, preferably with a triangular cross section.

In the anchoring element, the thermoplastic polymer in the second subregion can be formed such that a holding element is obtained, such that the anchoring element can be used as an abutment.

The thermoplastic polymer can be shaped such that a crown is formed in the second subregion.

The anchoring element can be used as a one-piece, two-phase implant.

According to a second aspect of the invention, a method for producing an abutment, or an abutment or dental prosthetic element on an implant, is specified, in which method the following steps are carried out:
making available a retaining pin or implant with a radially projecting collar which at least partially encloses the circumference of the retaining pin or implant, wherein a first subregion of the retaining pin or implant below the collar is designed as an anchor;
inserting the retaining pin or implant into a press mold, such that a second subregion above the collar is exposed;
filling the press mold with plastic granules; and
hot-pressing the plastic granules, such that a holding element or crown is formed in the second subregion, wherein the collar and the retaining pin or the implant in the second subregion are at least in part fully covered.

According to a further embodiment of the method, the plastic material is made available as a thermoplastic high-performance polymer, preferably PEEK.

According to a further embodiment of the method, the retaining pin is produced from a base metal, preferably titanium, from a ceramic, in particular aluminum oxide, or from zirconium dioxide.

According to a further embodiment of the method, the step of hot-pressing the plastic material is carried out in a temperature range of between 240° C. and 450° C., preferably in the range of between 380° C. and 400° C.

According to a further embodiment of the method, the step of filling the muffle mold with the plastic material is preceded by a preheating step, which is preferably carried out at between 600° C. and 650° C.

According to a further embodiment of the method, the pressing step is carried out under vacuum.

Moreover, a dental prosthetic arrangement is specified which has an above-described anchoring element, wherein the holding element of the abutment or of the implant serves as a support structure.

In the dental prosthetic arrangement, a crown, a bridge or a bar-like tooth replacement can be connected to one or more abutments.

The connection to the one or more abutments can be produced by adhesive bonding or screwing.

Furthermore, a method for overmolding an abutment or an abutment portion of an implant with a dental prosthetic arrangement, in which method the following steps are carried out:
making available an abutment or an implant with a holding element;
inserting the abutment or the implant into a muffle mold;
making available a wax model;
embedding the wax model in the muffle mold;
dewaxing the muffle mold;
filling the muffle mold with granules of a thermoplastic polymer; and
hot-pressing the granules in order to create the dental prosthetic arrangement with the abutment or the implant.

Furthermore, in this method, the high-performance polymer can comprise PEEK.

The high-performance polymer can also be mixed with a ceramic additive.

Finally, a method for thermoplastic overmolding or overspraying of dental prosthetic ready-made parts with an anchoring element as described above is specified, in which method the following steps are carried out:
making available an abutment or an implant with a holding element as dental prosthetic ready-made parts; and
overmolding or overspraying the dental prosthetic ready-made parts with a thermoplastic polymer.

A number of illustrative embodiments are explained in more detail below with reference to the drawing, in which:

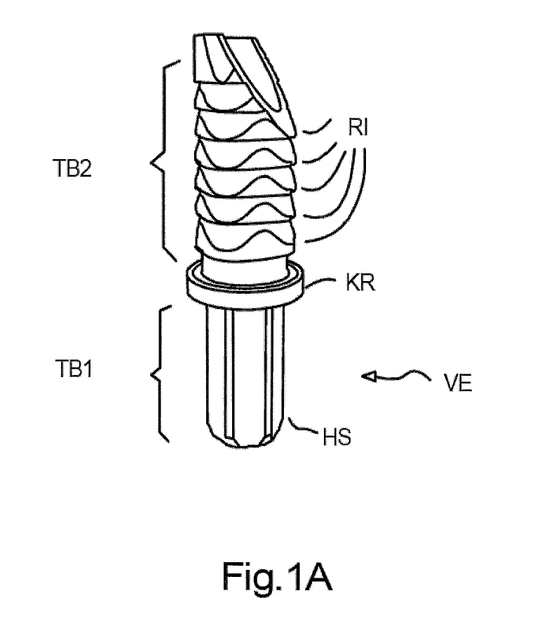

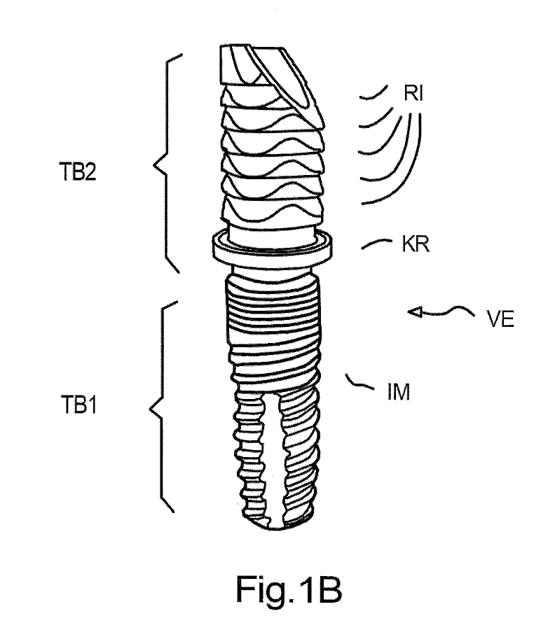

FIG. 1A shows a side view of a retaining pin as an anchoring element,

FIG. 1B shows a side view of an implant as an anchoring element,

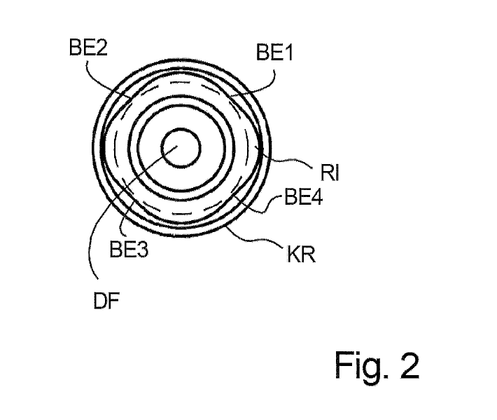

FIG. 2 shows the retaining pin from FIG. 1A in a plan view,

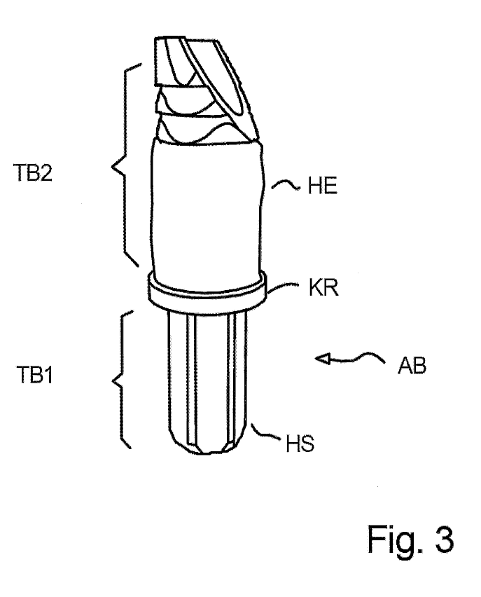

FIG. 3 shows a side view of an anchoring element according to the invention,

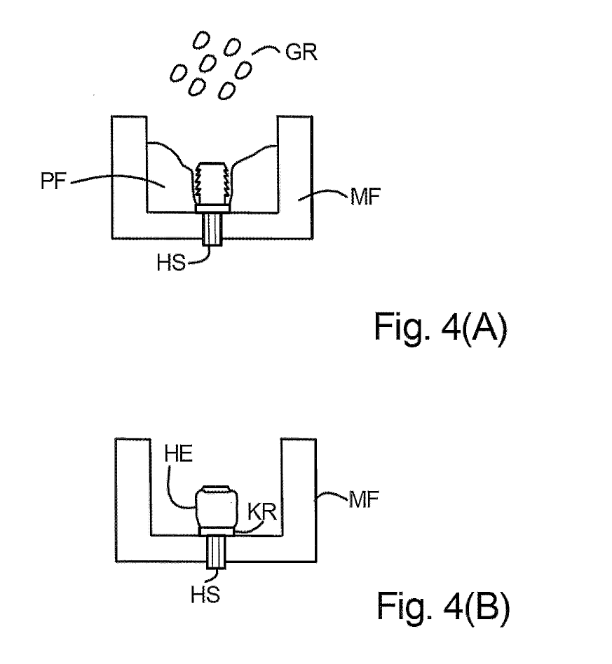

FIG. 4 shows a device for carrying out a method according to the invention,

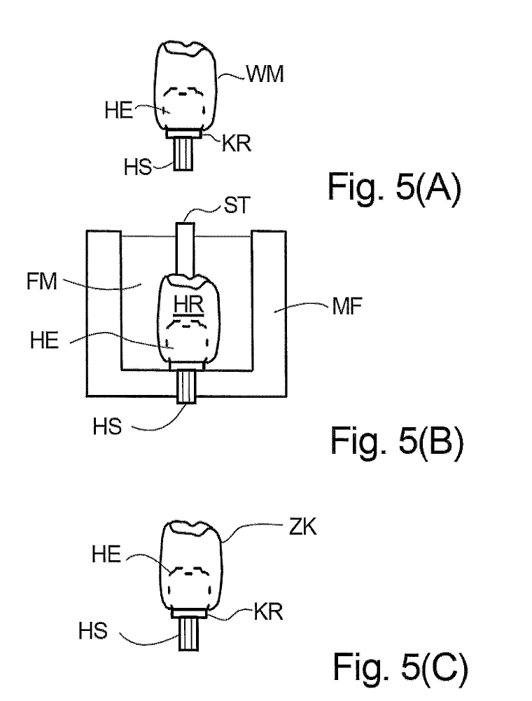

FIG. 5 shows a further device for carrying out a method according to the invention,

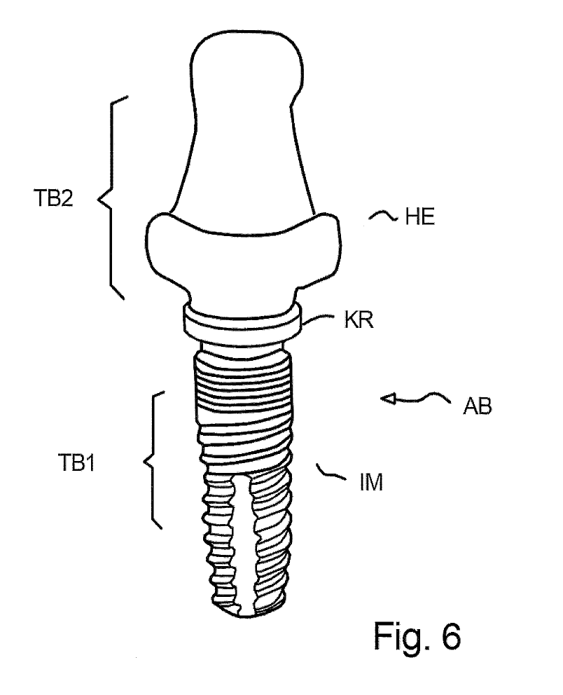

FIG. 6 shows a side view of a further anchoring element according to the invention, and

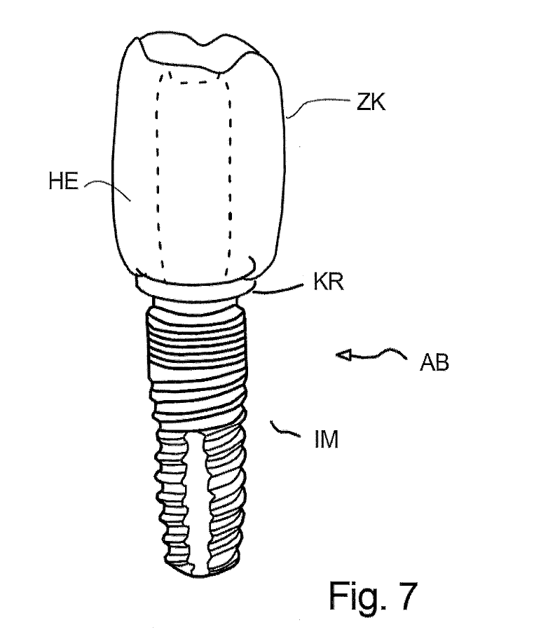

FIG. 7 shows a side view of a further anchoring element according to the invention.

In the figures, structural parts that are identical or that have an identical function are provided with the same reference sign.

Dental prosthetic arrangements can be fixed directly as an implant in a jaw bone or can be secured by a retaining pin in an implant that is already anchored in the jaw bone. Both embodiments, i.e. both the implant and also the retaining pin, are designated hereinbelow as an anchoring element. The design with the retaining pin is explained below with reference to FIG. 1(A) and the one with an implant with reference to FIG. 1(B).

An embodiment of the invention is explained in more detail below with reference to FIG. 1(A).

FIG. 1(A) shows a perspective side view of a retaining pin HS as anchoring element for an abutment AB. The retaining pin HS has a radially projecting collar KR which at least partially encloses the circumference of the retaining pin HS. Below the collar KR, a first subregion TB1 is formed which serves as an anchor in an implant not shown in FIG. 1(A). Above the collar KR is the second subregion TB2. Within the second subregion TB2, the retaining pin HS is profiled on its outside. This is shown in FIG. 1(A) as an arrangement of several ribs RI which are arranged in parallel in the axial direction and enclose the circumference of the retaining pin HS in the second subregion TB2. The ribs RI have, for example, a triangular cross section, although other configurations are likewise possible. In FIG. 2, the retaining pin HS from FIG. 1(A) is shown in a cross-sectional view. The cross-sectional view in FIG. 2 corresponds to a view from the direction of the end of the second subregion TB2. As can be seen from FIG. 2, than the diameter of the ribs RI is smaller than that of the collar KR. Furthermore, the ribs RI are designed in several areas BE1, BE2, BE3 and BE4 with a reduced diameter, resulting overall in a non-rotationally symmetrical cross section of the retaining pin HS. It will be noted that the non-rotationally symmetrical cross section of the retaining pin HS can be achieved in many different ways, for example with a different number of areas of reduced diameter, but also by means of areas of increased diameter or a different positioning of these areas.

It is likewise shown in FIG. 2 that the abutment AB has a passage DF, which extends all the way through the abutment AB along the longitudinal axis thereof. The passage DF can be used to lock the retaining pin HS, for example by means of a screw connection, after the retaining pin HS has been introduced into an implant.

FIG. 1(B) shows a perspective side view of an implant IM as anchoring element VE. The implant IM likewise has the radially projecting collar KR, which at least partially encloses the circumference of the retaining pin HS. The screw-shaped implant, which serves as an anchor in a jaw bone not shown in FIG. 1(B), is formed below the collar KR, in the first subregion TB1. Above the collar KR is the second subregion TB2. Within the second subregion TB2, the retaining pin HS is profiled on its outside. This is shown in FIG. 1(B) once again as an arrangement of several ribs RI which are arranged in parallel in the axial direction and enclose the circumference of the retaining pin HS in the second subregion TB2. FIG. 3 shows the abutment AB which was further developed according to the invention from the retaining pin HS according to FIGS. 1(A) and 2 in order to form a so-called hybrid abutment. Hybrid abutments have, in addition to the retaining pin HS, an additional element that can be used as a base for a dental prosthetic arrangement, e.g. a crown.

As can be seen from FIG. 3, a holding element HE is mounted above the collar KR and partially covers the collar KR and the retaining pin HS. The holding element HE is produced from a thermoplastic polymer, in particular PEEK. The holding element HE covers in particular the grooves RI, which serve as retentive areas, such that, after hot pressing, the plastic material of the thermoplastic polymer can retreat into these areas when cooling.

The retaining pin HS is produced from a base metal, in particular titanium, from a ceramic, in particular aluminum oxide, or from zirconium dioxide. The abutment AB shown in FIG. 3 can be used as a support element for securing crowns, bridges or implants in dentistry.

A method for producing the abutment AB according to the invention is explained in more detail below with reference to FIG. 4. In a first step, a retaining pin of the kind described in connection with FIG. 1(A), or an implant IM as described in connection with FIG. 1(B), is made available as an anchoring element. The retaining pin HS or the implant IM is inserted into a press mold PF, such that the second subregion TB2 above the collar KR is exposed. After a shaping step, plastic granules GR are made available and are introduced into the press mold PF after liquefying by heating. The plastic granules GR are then hot-pressed, for example under vacuum, such that the holding element HE is formed in the second subregion TB2. The holding element HE is designated as an abutment part of the implant IM.

The temperature to be set is determined by the materials used for the holding element HE and for the retaining pin HS or implant IM. When using PEEK and titanium or zirconium dioxide, a temperature of approximately 380° C. has proven particularly effective for ensuring that the holding element HE seamlessly encloses the retaining pin HS on the outside thereof above the collar KR. This temperature is above the melting point of PEEK but below the temperature range at which the materials used would begin to degrade.

Generally, the step of pressing the plastic granules GR can be carried out in a temperature range of between 240° and 450°, preferably of between 380° and 400°.

Before the actual step of pressing, a preheating step can be carried out, for example at 650°. Similarly, the surface in the second subregion TB2 can be roughened prior to the pressing.

As has been shown, in the procedure described above, the holding element HE forms a seamless connection with the retaining pin HS or implant IM, and this connection withstands very considerable loads.

As has already been mentioned, a hot-pressing temperature of 380° has proven particularly effective when PEEK is used for the holding element HE and titanium, ceramic or zirconium dioxide is used for the retaining pin HS. The grooves RI serve as retentive areas which, after the plastic material has cooled, favor shrinkage. During the hot pressing, molecular chains of the PEEK presumably connect to superficially oxidized titanium of the retaining pin HS or implant IM. This chemical connection supports the adherence of the plastic material over the retaining pin HS or implant IM, such that the seamless covering described above is achieved.

According to this method, it is possible to form an abutment AB that can take up very considerable forces. The abutment AB can be used in a dental prosthetic arrangement, wherein the holding element HE of the abutment serves as a support structure for a crown, a bridge or a bar-like tooth replacement. The connection of the dental prosthetic arrangement to the abutment AB can be carried out by screwing or adhesive bonding. It is likewise possible to form an implant IM in which the abutment portion is formed by the holding element HE.

A method for overmolding an abutment or an abutment portion of an implant with a dental prosthetic arrangement is explained below with reference to FIGS. 5(A) to 5(C).

For this purpose, an abutment AB of the kind described in connection with FIG. 3 is made available in a first step. In the area of the holding element HE, the abutment AB is provided with a wax model WM which, in the example shown, is intended to represent the subsequent crown or individual abutment. The abutment AB is inserted together with the wax model WM into a muffle mold MF, which is then provided by means of a suitable filler material FM in order to cover the area outside the wax model WM. During the embedding of the the wax model WM in the filler material FM, pinning is also performed in order to maintain an access to the region of the wax model WM.

The pinning is indicated schematically in FIG. 5(B) by the pin ST. It is worth mentioning here that the abutment AB comprises a passage DF that extends all the way though the abutment AB in the axial direction.

Heating results in so-called dewaxing, wherein the wax model WM begins to melt and burns out, wherein the porous structure of the filler material supports the formation of a cavity HR within the filler material FM. Consequently, the cavity HR remains within the filler material FM, as is shown in FIG. 5(B).

The muffle mold MF is then filled by means of plastic granules GR, which are compressed by means of a stamp (not shown) in preparation for the pressing. The plastic granules can in turn be made available as a high-performance polymer PEEK. In addition, it is conceivable that the PEEK material is mixed with a ceramic additive, for example in order to achieve a color match of the tooth crown.

After the muffle mold MF has been filled with the granules, the material in the muffle is heated in a preheating furnace at 400° C., after which the granules are hot-pressed, wherein the pressing is carried out in the region around 380° C. The actual pressing takes place in a vacuum, such that the subsequent crown can be formed free of bubbles.

After the cooling, a crown ZK as shown in FIG. 5(C) is obtained. The crown ZK sits on the holding element HE, wherein the retaining pin HS can be used as anchoring point in an implant.

In another embodiment of the method according to the invention, an abutment AB corresponding to the one shown in FIG. 1(A) is used as a starting point. The abutment AB consequently has no holding element HE. By means of the hot-pressing with the thermoplastic polymer, a structure is therefore generated that corresponds to the one in FIG. 5(C), wherein the encapsulation of the retaining pin HS with the thermoplastic polymer is carried out in a single step without prior formation of a holding element HE.

A further embodiment of the invention is explained with reference to FIG. 6.

As can be seen from FIG. 6, the holding element HE as an abutment portion made of PEEK is again mounted above the collar KR. Below it is the implant IM. The holding element HE above the implant IM covers in particular the grooves RI, which serve as retentive areas such that, after hot-pressing, the plastic material of the thermoplastic polymer can retreat into these areas during cooling. The implant IM is produced from a base metal, in particular titanium, from a ceramic, in particular aluminum oxide, or from zirconium dioxide.

After production, the the holding element HE made of PEEK can be worked and thus individualized, such that, after insertion into a jaw bone, the implant IM shown in FIG. 6 can be used as a support element for securing crowns or bridges in dentistry. The embodiment shown can be designated as a one-piece, two-phase implant.

The production method then follows the one described in connection with FIG. 4, wherein a steel mold can be used instead of the muffle mold MF in order to satisfy hygiene requirements during the insertion of the implant IM into a jaw bone.

A further embodiment is shown in FIG. 7. Here, a crown ZK is injected directly onto an implant. This procedure directly generates a dental prosthetic element that can be inserted into a jaw bone.

Moreover, it is possible to use the invention in a method for thermoplastic overmolding or overspraying of dental prosthetic ready-made parts. Here, the anchoring element is made available either as an abutment AB in accordance with FIG. 3 or as an implant in accordance with FIG. 6. Thereafter, the dental prosthetic ready-made parts are overmolded or oversprayed with the thermoplastic polymer.

The anchoring element according to the invention and the method according to the invention have advantages over the gold and ceramic constructions known in the prior art. Firstly, the hardened PEEK proves easy to work and has no interactions of any kind with other materials. On account of the high load-bearing capacity and breaking strength along with a low weight, a very robust tooth prosthesis is created. It can be used with an exact fit, reproducibly and free of stress cracks. Using additives, e.g. ceramic materials, the crown ZK made of a high-performance polymer can be matched in color to the other teeth or crowns, and there is no irritation of the gums.

It has been shown that the high-performance polymer used, namely PEEK, is able to take up masticatory forces of up to 1000 MPa, such that a high breaking strength is achieved with, at the same time, high safety reserves. This material is additionally biocompatible, as has already been shown in human medicine, for example in artificial hip prostheses, finger joints or heart valves.

The example shown, with a crown ZK, serves merely to illustrate the invention. It goes without saying that the abutment AB according to the invention and the method according to the invention can be used in many different dental prosthetic applications. These can include crown bridges or similar bar structures, for example.

1. An anchoring element for a dental prosthetic arrangement, which anchoring element can be anchored in a jaw bone or implant in a first subregion (TB1) and is suitable for receiving or forming a dental prosthetic element (ZK) in a second subregion (TB2), wherein the anchoring element has, between the first subregion (TB1) and the second subregion (TB2), a radially projecting collar (KR) which at least partially encloses the circumference of the anchoring element, wherein the region above the collar (KR) of the anchoring element is at least in part fully covered with a thermoplastic material.

2. The anchoring element as claimed in claim 1, which anchoring element comprises a retaining pin (HS), which can be inserted into an implant and preferably has a non-rotationally symmetrical cross section, or an implant (IM), which can be anchored in a jaw bone.

3. The anchoring element as claimed in claim 1, which anchoring element has a roughened surface in the second subregion (TB2).

4. The anchoring element as claimed in claim 1, in which anchoring element the thermoplastic polymer is PEEK.

5. The anchoring element as claimed in claim 1, which anchoring element is produced a base metal, preferably titanium or a titanium alloy, from a ceramic, in particular aluminum oxide, or from zirconium dioxide, or from a material suitable for use in dentistry.

6. The anchoring element as claimed in claim 1, which anchoring element has a profiled surface on its outside in the second subregion (TB2).

7. The anchoring element as claimed in claim 6, in which anchoring element the profiled surface comprises several ribs (RI) arranged in parallel in the axial direction, preferably with a triangular cross section.

8. The anchoring element as claimed in claim 1, in which anchoring element the thermoplastic polymer in the second subregion (TB1) is formed such that a holding element (HE) is obtained, such that the anchoring element can be used as an abutment (AB).

9. The anchoring element as claimed in claim 1, in which anchoring element the thermoplastic polymer is shaped such that a crown (ZK) is formed in the second subregion (TB1).

10. The anchoring element as claimed in claim 9, which anchoring element can be used as a one-piece, two-phase implant.

11. A method for producing an abutment, in which method the following steps are carried out:
making available a retaining pin (HS) or implant (IM) with a radially projecting collar (KR) which at least partially encloses the circumference of the retaining pin (HS) or implant (IM), wherein a first subregion (TB1) of the retaining pin (HS) or implant (IM) below the collar (KR) is designed as an anchor;
inserting the retaining pin (HS) or implant (IM) into a press mold (PF), such that a second subregion (TB2) above the collar (KR) is exposed;
filling the press mold (PF) with plastic granules (GR); and
hot-pressing the plastic granules (GR), such that a holding element (HE) or crown (ZK) is formed in the second subregion (TB2), wherein the collar (KR) and the retaining pin (HS) or the implant (IM) in the second subregion (TB2) is at least in part fully covered.

12. The method as claimed in claim 11, in which method the plastic granules (GR) are made available as a thermoplastic polymer, preferably PEEK.

13. The method as claimed in claim 11, in which method the retaining pin (HS) or the implant (IM) is produced from a base metal, preferably titanium or a titanium alloy, from a ceramic, in particular aluminum oxide, or from zirconium dioxide, or from a material suitable for use in dentistry.

14. The method as claimed in claim 11, in which method the step of hot-pressing the plastic granules (GR) for pressing the abutment portion on the implant (IM) or the abutment (AB) is carried out in a temperature range of between 240° C. and 450° C., preferably in the range of between 380° C. and 400° C.

15. The method as claimed in claim 11, in which method the step of filling the press mold (PF) with the plastic granules (GR) is preceded by a preheating step, which is preferably carried out at between 600° C. and 650° C.

16. The method as claimed in claim 11, in which method the pressing step is carried out under vacuum.

17. A dental prosthetic arrangement with at least one anchoring element as claimed in claim 1, wherein the holding element (HE) of the abutment (AB) or of the implant (IM) serves as a support structure.

18. The dental prosthetic arrangement as claimed in claim 17, in which a crown, a bridge or a bar-like tooth replacement can be connected to one or more abutments (AB).

19. The dental prosthetic arrangement as claimed in claim 18, in which the connection to the one or more abutments (AB) can be produced by adhesive bonding or screwing.

20. A method for overmolding an abutment or an abutment portion of an implant with a dental prosthetic arrangement, in which method the following steps are carried out:
making available an abutment (AB) or an implant (IM) with a holding element (HE);
inserting the abutment (AB) or the implant (IM) into a muffle mold (MF);
making available a wax model (WM);
embedding the wax model (WM) in the muffle mold (MF);
dewaxing the muffle mold (MF);
filling the muffle mold (MF) with granules of a thermoplastic polymer; and
hot-pressing the granules in order to create the dental prosthetic arrangement (ZK) with the abutment (AB) or the implant (IM).

21. The method as claimed in claim 20, in which method PEEK is used as thermoplastic polymer.

22. The method as claimed in claim 20, in which method the thermoplastic polymer is mixed with a ceramic additive.

23. The method as claimed in claim 20, in which method the abutment (AB) or the abutment portion of the implant (IM) is made available as an anchoring element for a dental prosthetic arrangement, which anchoring element can be anchored in a jaw bone or implant in a first subregion (TB1) and is suitable for receiving or forming a dental prosthetic element (ZK) in a second subregion (TB2), wherein the anchoring element has, between the first subregion (TB1) and the second subregion (TB2), a radially projecting collar (KR) which at least partially encloses the circumference of the anchoring element, wherein the region above the collar (KR) of the anchoring element is at least in part fully covered with a thermoplastic material.

24. A method for thermoplastic overmolding or overspraying of dental prosthetic ready-made parts with an anchoring element as claimed in claim 1, in which method the following steps are carried out:
making available an abutment (AB) or an implant (IM) with a holding element (HE) as dental prosthetic ready-made parts; and
overmolding or overspraying the dental prosthetic ready-made parts with a thermoplastic polymer.

25. The method as claimed in claim 24, in which method PEEK is used as thermoplastic polymer.
